(19) United States
(12) Patent Application Publication
(10) Pub. No.: US 2009/0026643 A1
(43) Pub. Date: Jan. 29, 2009

(54) Method and System for Producing a Dental Prosthesis

(75) Inventors: Thomas Wiest, Hunfeld (DE); Christoph Weiss, Bremen (DE); Stephan Dierkes, Bremen (DE); Helmut Laschutza, Ritterhude (DE)

Correspondence Address: BROMBERG & SUNSTEIN LLP, 125 SUMMER STREET, BOSTON, MA, 02110-1618, US

(73) Assignee: BEGO Bremer Goldschlagerei Wilh. Herbst GmbH & Co., Bremen (DE)

(21) Appl. No.: 12/094,725

(22) PCT Filed: Nov. 20, 2006
(86) PCT No.: PCT/EP2006/068641

§ 371 Date: Sep. 29, 2008

(30) Foreign Application Priority Data
Nov. 22, 2005 (DE) 10 2005 055 526.8

(51) Int. Cl. A61C 13/00; B29C 33/38

(52) U.S. Cl. 264/16; 264/222

(57) ABSTRACT

The invention relates to a method (100, 200, 300) for producing a dental prosthesis (17) comprising a framework (3) and a veneer (15), in particular for creating a crown, a bridge, an inlay or an onlay. The invention also relates to a system (40, 50) for creating a dental prosthesis (17) comprising a framework (3) and a veneer (15) as well as a corresponding computer program. In order to be able to produce the dental prosthesis (17) independently of the manual dexterity of the operator, in a short time and with a consistent quality, the following steps are provided: defining (110, 210, 310) three-dimensional geometric data for the veneer (15), providing (101) or producing (218, 318) the framework (3), creating (120, 220, 320) a model (5, 5a, 5b, 5c, 5d) of the veneer (15) on the basis of the three-dimensional geometric data for the veneer (15), on the framework (3) or separately, making (124, 224, 324) a negative mould (11) of the veneer (15) by embedding (126, 226, 326) the model (5, 5a, 5b, 5c, 5d) between the framework (3) and a moulding material (9) and then removing (128, 228, 328) the model (5, 5a, 5b, 5c, 5d) and filling (130, 230, 330) the negative mould (11) with veneering material to produce the veneered dental prosthesis (17).

The invention relates to a method for producing a dental prosthesis comprising or consisting of a framework and a veneer, in particular for creating a crown, a bridge, an inlay or an onlay. The invention also relates to a system for creating a dental prosthesis comprising or consisting of a framework and a veneer as well as a corresponding computer program.

A dental prosthesis, such as a crown, for example, can be used to restore, replace or replicate a tooth that has been damaged or destroyed. A number of different options are available regarding the material from which the prosthesis is made.

In functional terms, part or all of a tooth can be adequately restored or replaced by a metal prosthesis. For aesthetic reasons, however, there is in many cases a reluctance to make a dental prosthesis entirely from metal.

The use of glass-ceramics to make prostheses is on the increase, for reasons both of aesthetics (translucency) and above all of biocompatibility. This material is known as a press ceramic because the manufacturing process involves pressing the molten glass into a mould. Colour gradations can be obtained on this prosthesis by subsequently painting it with a brush. Owing to its low strength, however, the field of application of this type of full-ceramic material is restricted to crowns and to anterior dental bridges with a maximum of three units.

The best aesthetic results are obtained, however, by providing a ceramic or metal framework with a veneer. This veneer is applied to at least part of the framework. The framework determines the main mechanical properties, such as strength and flexural strength, whilst the optical properties and the general surface properties of the dental prosthesis are established by the veneer. Plastics or ceramics are generally used as veneering materials. Veneering ceramics are in many cases preferred over veneering plastics, since only the excellent mechanical and physical values of ceramics such as hardness and strength permit a long-term use.

When using veneering ceramics it is important to match the coefficients of thermal expansion (CTE) of the framework material and of the veneering material. If the coefficients differ too greatly, stress can occur. This can lead to separation or to cracks in the veneer.

In many cases the veneering material is applied by hand to the framework, using a brush for example. This veneering method involves coating a ceramic or metal framework with layers of a dentine core compound, a transparent compound and an incisal compound, for example. An opaquing compound is additionally also applied to the metal framework in advance. The application of these layers and the associated firing processes are time consuming, and depending on the skill and dexterity of the operator, the quality of the result may vary.

DE 27 05 770 A1 proposes the use of electrophoresis to apply a veneering ceramic to a metal framework. Electrophoretic deposition allows only uniform layers to be created, however. It does not allow for a creative influencing of the outer contour (other than the coating thickness). Manual finishing is therefore unavoidable. Furthermore, this method is only suitable for metal frameworks, since the surface to be coated must be electrically conductive.

Methods for producing veneered metal and ceramic crowns are known from U.S. Pat. No. 5,092,022. The crown is produced from matching defined components (framework and veneer), the outer contour of the framework and the inner contour of the veneer being defined in a standardised manner and only the inner contour of the framework and the outer contour of the veneer being adapted to the intended application by means of subtractive shaping. Alternatively, the framework is built first and the inner contour of the veneer is machined to match the outer contour of the framework before the two are assembled. U.S. Pat. No. 5,092,022 also proposes producing a framework in the desired shape together with an outer mould reproducing the outer contour of the veneer, combining the framework and outer mould to make a casting mould and casting a plastic veneer directly onto the framework.

Standardised, defined moulds can often be adapted only with difficulty to the specific conditions of an individual case. If the framework and veneer are adapted to one another by machining, as in U.S. Pat. No. 5,092,022, the manufacturing tolerances must be very small, and this is only possible with a correspondingly large amount of effort. Furthermore, the casting mould according to U.S. Pat. No. 5,092,022 consists of at least two components, as a result of which casting defects occur, especially at the contact surfaces between the mould parts, which require increased finishing.

Manually modelling a wax model of a veneering ceramic structure, embedding the model together with the framework, then burning out the wax model and filling the mould thus created with a ceramic material, for example a press ceramic, in order to manufacture the prosthesis, is known (see G. G. J. Dröge: “Die Metallgerüst-Konstruktion für das Heiβpressverfahren”, das dental-labor, No. 3/1977, G. G. J. Dröge: “Die Porzellan-Press-Technik (I)”, das dental-labor, No. 4/1969 and E. R. McPhee: “Heiβpressverfahren bei der Porzellan/Metall-Aufbrenntechnik”, das dental-labor, No. 10/1976).

This method, which is known as the “lost wax” method, is used according to DE 199 29 441 A1, for example, for producing fully anatomically modelled crowns or partly anatomically modelled frameworks.

A method is known from EP 0 033 492 A1 for producing a wax casting model for a primary section of a telescopic crown in which the contour of the casting model is calculated on the basis of stored geometric data for a tooth stump and then subtractively shaped.

WO 03/017864 A1 teaches a method for producing a solid cast metal prosthesis, wherein the geometric data for a set of teeth is used to produce by automated means a prototype of the prosthesis to be moulded, which prototype then serves to create a casting mould for the entire prosthesis using the lost wax method.

The methods known from EP 0 033 492 A1 and WO 03/017864 A1 can only be used to produce a one-piece prosthesis from a single material and not, however, a dental prosthesis comprising a framework and a veneer.

A method for producing a dental prosthesis comprising a framework and a veneer is known from DE 199 22 870 A1. In this case the manual application of veneering material is replaced by a computer-aided, automated application using coating nozzles. This method requires a complex equipment construction, however, and so its use makes little sense in practice.

WO 2005/046502 A1 relates to a system and an arrangement for producing a dental replacement component. The system is fully automated and uses three-dimensional geometric data for the entire restoration, comprising framework and veneer, but not three-dimensional geometric data for the veneer.

According to EP 1 543 797 A1, and similarly to the teaching of U.S. Pat. No. 5,092,022, a mould for press-moulding veneering material is created by milling or grinding, on the basis of a set of geometric data for the prosthesis to be created.

The mould holds the framework to be veneered, and the veneering ceramic is injected into the remaining cavity to fill it.

Multi-piece casting or pressing moulds readily lead to casting defects at the contact surfaces of the mould parts, with burrs or casting lugs arising in particular. In some cases complex shapes require the mould to be divided up further, since otherwise the tools used to machine the mould would not be able to reach poorly accessible places, such as a relief cut.

One object of the invention is to provide a method and a system for creating a dental prosthesis comprising a framework and a veneer, together with a corresponding computer program, wherein the aforementioned problems are avoided or reduced.

In particular, it should be possible to produce the dental prosthesis in a desired shape largely independently of the manual dexterity of the operator, in a short time and with a consistent quality. If the desired shape already corresponds to the ready-to-use shape, then the need for extensive finishing to eliminate manufacturing defects or to adapt the prosthesis to the insertion point within the set of teeth can be largely avoided.

The dental prosthesis may consist solely of the framework and the veneer, for example. However, it can also be provided for the dental prosthesis to include further elements in addition to the framework and the veneer.

According to the invention one aspect of the above object is achieved by a method for creating a dental prosthesis comprising a framework and a veneer, in particular a crown, a bridge, an inlay or an onlay, which comprises the following steps:
Defining three-dimensional geometric data for the veneer,
Providing or producing the framework,
Creating a model of the veneer on the basis of the three-dimensional geometric data for the veneer, on the framework or separately,
Making a negative mould of the veneer by encasing the model between the framework and a moulding material and then removing the model, and
Filling the negative mould with veneering material to produce the veneered dental prosthesis.

The three-dimensional geometric data for the veneer defines its geometry completely. The model of the veneer created on the basis of the three-dimensional geometric data may differ from the veneer itself, however, with regard to the inner contour for example, in order for example to leave space for layers to be provided between the framework and the model of the veneer, for example adhesive and/or liner layers or opaquing layers.

If the model of the veneer differs in its inner contour from the veneer that is subsequently to be produced (whose three-dimensional geometric data has been defined), a gap or an additional layer is provided between the framework and the model when the negative mould is made, for example an opaquing layer. The model is preferably mounted on the framework by hand, preferably using an articulator.

A further aspect of the above object is achieved according to the invention by a system for creating a dental prosthesis comprising a framework and a veneer, in particular a crown, a bridge, an inlay or an onlay, comprising:
A definition means for defining three-dimensional geometric data for the veneer,
A framework preparation means for providing or producing the framework,
A modelling means for creating a model of the veneer on the basis of the three-dimensional geometric data for the veneer, on the framework or separately, and
A filling means for filling a negative mould, made by encasing the model between the framework and a moulding material and then removing the model, with veneering material to produce the veneered dental prosthesis.

A further aspect of the invention relates to a computer program comprising computer programming code, which causes a computer system for creating a dental prosthesis comprising a framework and a veneer to execute a method according to the invention when the computer program is run on the computer system.

Apart from applying the layer of veneering ceramic by hand, only the press-moulding of veneering ceramics has become established practice in dentistry. Press-moulding the veneering ceramic has hitherto been the less aesthetic but significantly more cost-effective solution. This more cost-effective solution is further improved with the present invention. The model for the veneer is created on the basis of three-dimensional geometric data for the veneer, preferably by means of CAD/CAM.

The model of the veneer is preferably created not on the model but separately, preferably by means of a free-form method (rapid prototyping method).

In a preferred embodiment, the method according to the invention involves as an additional step an additive and/or subtractive shaping of the framework by means of computer-aided manufacturing, preferably by means of a rapid prototyping method. Integrating the production and/or adaptation of the framework into the method allows the dental prosthesis to be created as a whole, independently from pre-machined starting products, such as a basic framework which requires finishing, for example, and this can save time and labour.

In a further embodiment of the method according to the invention the framework is shaped on the basis of predefined three-dimensional geometric data. The framework is created in a shape or with a corresponding contour which is determined at least in part by the three-dimensional geometric data. The shaping of the framework does not have to be restricted to shaping the framework with a predefined layer thickness as an example of one-dimensional geometric data on a model of the tooth stump, for example. The complete shape of the framework can advantageously be predefined, which in particular allows specific features of the individual case to be taken into account and incorporated. Anatomical moulds of the framework can thus be created, for example.

In a further embodiment of the invention the framework comprises or consists of a metal, a metal alloy and/or a ceramic material. Owing to their mechanical properties, metals and metal alloys are suitable for the functional replacement of a tooth or part of a tooth. In functional terms, tooth-like properties can also be achieved with suitable ceramics. The mechanical properties of the entire prosthesis can be extensively defined through the use of suitable materials for the framework.

In a preferred embodiment of the method according to the invention, user inputs and/or three-dimensional geometric data for the framework, the prosthesis to be created, a set of teeth and/or a tooth stump, preferably three-dimensional geometric data for the framework and a set of teeth, are used to define the three-dimensional geometric data for the veneer. In a particularly simple manner, the outer contour of the framework and the geometrical data for the opposite set of teeth can be used to calculate a desirable contour for the veneer. The geometry of the tooth stump onto which the prosthesis is to be mounted can also be taken into consideration when defining the geometric data for the veneer, however. This can also be done with regard to mechanical properties of the entire prosthesis, for example. The further geometric data for the set of teeth or partial set of teeth into which the prosthesis is to be fitted can also be taken into account in order to render finishing work largely redundant. In individual cases it is also sensible to give the user the opportunity to influence the definition of the geometric data for the veneer or the geometric data itself.

In an advantageous embodiment the method according to the invention involves recording three-dimensional geometric data for the framework, a set of teeth and/or a tooth stump. Recording the three-dimensional geometric data enables unnecessary error sources to be eliminated, such that geometric data can no longer be corrupted by a data transmission error, for example, or an operator can no longer mix up the data and use the geometric data belonging to a different prosthesis. If the three-dimensional geometric data for an individual patient's teeth is recorded, then it is possible to choose to use standardised values or the individually determined values to define the geometric data for the veneer or the framework.

Recorded and/or defined three-dimensional geometric data is preferably stored to allow a subsequent verification of the process steps and intermediate results or a statistical evaluation.

In a further embodiment of the method according to the invention, the model of the veneer is created by computer-aided means, preferably by means of a rapid prototyping method, in particular by means of milling, 3D printing and/or stereolithography, especially if the model is created separately rather than on the framework. If the defined three-dimensional geometric data for the veneer is stored on a computer, it can easily be used to create the model by the desired means. Error sources arising from manual processing are avoided in this way.

If no data is available for the opposite set of teeth, the model of the veneer can also be made larger than necessary to begin with. The dental technician will then place the veneered framework in an articulator, for example, and remove the excess veneering material by grinding or milling.

In order to obtain an improved aesthetic, a prosthesis on which only a veneering ceramic layer of a uniform colour has been applied can subsequently be further modified through the use of colours.

In an advantageous embodiment, a colour gradation is established in the veneer when the negative mould is filled, in particular by press-moulding a blank with a colour gradation. Even if the colour gradation in the blank is modified as a result of being introduced into the negative mould and press-moulded, a desired colour gradation in the veneer can be achieved with a suitable preparation of the blank.

In an advantageous embodiment, the fad that further layers are to be applied to the veneer is taken into consideration when creating the model for the veneer. This approach can improve the aesthetics of the prosthesis. The veneer here can be a veneer based on dentine core compound. Further layers, based for example on transparent compound and incisal compound, can then be applied manually in subsequent steps or can likewise be created by press-moulding (in the same way as the veneer); in the latter case multiple layers/veneers are applied in succession. A veneered framework can be provided with a (further) veneer in the same way as a simple framework without a veneer in accordance with the present invention.

Larger veneers created beforehand on the basis of dentine compound can also be ground down or milled from the prosthesis to make space for subsequent layers.

In an advantageous embodiment of the method according to the invention, a positive mould for at least one channel to simplify filling of the negative mould and/or removal of the model, in particular for a casting channel or injecting channel, is added to the model of the veneer. The addition of the positive mould simplifies the subsequent use of the model. The positive mould or its geometric data can be incorporated into the creation of the model. Alternatively, the positive mould can be added to the model by suitable means after creation of the model.

In a further embodiment of the method according to the invention the created model of the veneer has a closed outer surface with cavities on the side facing the framework. Such a model reproduces the outer contour of the veneer that is essential for making the negative mould of the veneer, whilst there are recesses in the inner region or on the side facing the framework which allow material savings to be made. In addition, the cavities make it easier to remove the model material by melting or burning it out, for example. It is also possible for only the lower edge of the model to lie against the framework and for an accurate fit of the model to be dispensed with in the inner region, in other words between the model and the framework, without creating a gap between the model and framework which might allow the penetration of embedding compound, for example.

In an advantageous embodiment of the method according to the invention, removing the model of the veneer involves burning and/or melting out the model of the veneer, the moulding material being a fireproof material, in particular an embedding compound (conventionally used in the dental sector). Burning or melting out, in other words establishing appropriately elevated temperatures and/or environmental conditions to alter the aggregate status and/or the chemical composition, is a simple and effective means of removing the material of the model of the veneer from the mould and thus preparing the mould to be filled with veneering material. As far as possible the moulding material itself remains inert or alters its composition or geometry only in a controlled manner. The same is preferably true of the framework. The materials are matched to one another in terms of their thermal expansion, for example. A phosphate-bound embedding compound is preferably used. In these embedding compounds the thermal expansion is established by means of what is known as quartz and cristobalite inversion.

In a preferred embodiment of the method according to the invention the model of the veneer can be burnt without residue and/or melted out without residue and is created in particular from a wax and/or a plastic. If the material has already been removed from the mould without residue by burning out and/or melting out, additional process steps to clean the mould, by rinsing with a suitable solvent for example, can be dispensed with.

Waxes and plastics, in particular light-curing resin and light-curing wax, are preferably used as model materials.

In addition to or as an alternative to melting out the model material, a sublimation of the model material can also occur during removal.

The expulsion of the model material from the mould can additionally be achieved by introducing the necessary heat into the mould along with the filling material, for example by hot pressing.

In an advantageous embodiment of the method according to the invention the negative mould is filled with an injectable, preferably free-flowing, veneering ceramic material, in particular by means of a hot pressing method (pressing temperature: ˜900° C.). A glass-ceramic veneer is particularly suitable for imparting a tooth-like appearance to the dental prosthesis. As compared with the option of using plastics, the use of ceramics offers inter alia the advantages of better compatibility, stability, strength and service life.

An alternative method is slip casting. Here the cavity is filled with a slip containing a dispersant and glass-ceramic and/or veneering ceramic particles in order to produce a green compact of the veneer.

It is also possible to press a blank into the mould in a similar manner to hot pressing, the blank containing a binder (e.g. wax or a plastic/thermoplastic) and glass-ceramic and/or veneering ceramic particles, in order to produce a green compact. In contrast to actual hot pressing, the temperature in this case is much lower, generally in the range from around 50° C. to 150° C.

The green compact created in this way is then heat treated together with the framework so that it melts or sinters and hardens accordingly. It must however be borne in mind that a loss of volume can occur here, which must be taken into consideration beforehand when determining the outer contour.

In a further advantageous embodiment, the method according to the invention is designed so as to create and use a multi-piece model and/or so as to create a multi-piece dental prosthesis. A multi-piece model is advantageous if for example the model is created separately from the framework and a one-piece model cannot be mounted onto the framework.

In a particularly preferred embodiment, the method according to the invention for creating a dental prosthesis comprising a framework and a veneer, in particular a crown, a bridge, an inlay or an onlay, comprises the following steps:
Additive and/or subtractive shaping of the framework by means of computer-aided manufacturing using predefined three-dimensional geometric data for the framework,
Defining three-dimensional geometric data for the veneer using the three-dimensional geometric data for the framework, in particular with additional use of user inputs and/or predefined three-dimensional geometric data for a set of teeth into which the dental prosthesis is to be fitted,
Creating a model of the veneer by computer-aided means on the basis of the three-dimensional geometric data for the veneer, on the framework or separately,
Making a negative mould of the veneer by encasing the model between the framework and a moulding material and then melting out and/or burning out the model, and
Filling the negative mould with a press ceramic to produce the veneered dental prosthesis.

In the case of metal frameworks it can be useful to specifically prepare the framework before mounting the model. Frameworks made from noble metal or non-noble metal are prepared by sandblasting and oxidative annealing, for example, to produce adhesive oxides for bonding to the surface. A special base compound (opaquing compound) can also be applied to conceal unattractive grey shades in a metal framework.

In the case of a ceramic framework, on the other hand, a liner can be thinly applied. The purpose of this is not to conceal the framework, however, but to give it a certain base colour.

It has been found that this combination of process steps permits dental veneered prostheses to be created particularly effectively.

The invention is described below by reference to the appended figures:

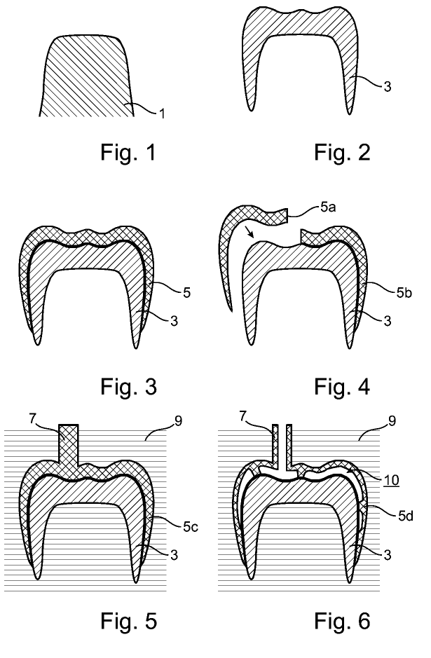

FIG. 1-FIG. 9 show schematic cross-sections of the intermediate results of the creation of a dental prosthesis according to the invention.

FIG. 10 shows a flow diagram illustrating a first embodiment of the method according to the invention for creating a dental prosthesis.

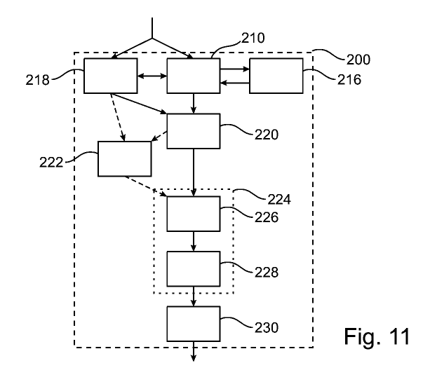

FIG. 11 shows a flow diagram illustrating a second embodiment of the method according to the invention for creating a dental prosthesis.

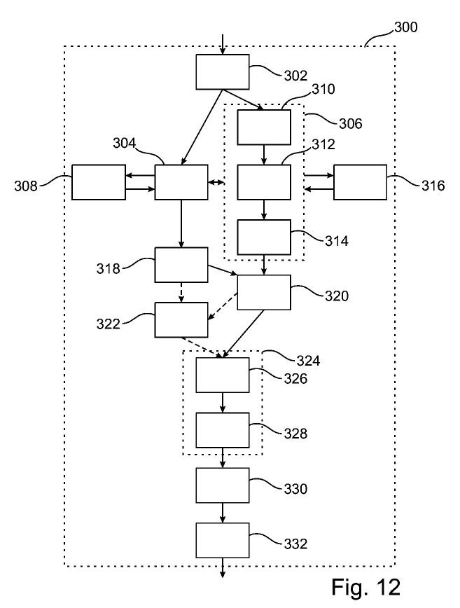

FIG. 12 shows a flow diagram illustrating a third embodiment of the method according to the invention for creating a dental prosthesis.

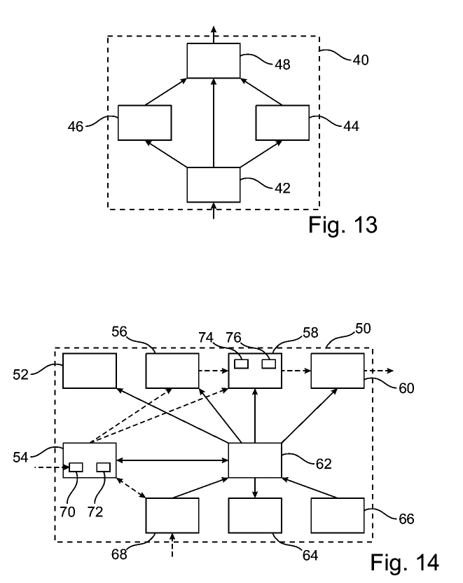

FIG. 13 shows a schematic view of a first embodiment of the system according to the invention for creating a dental prosthesis.

FIG. 14 shows a schematic view of a second embodiment of the system according to the invention for creating a dental prosthesis.

FIG. 1 shows a tooth stump or the model of a tooth stump 1. Of particular importance here is the geometric data for the outer contour of the tooth stump, to which the inner contour of the framework (see FIG. 2) is matched.

FIG. 2 shows a framework 3 with an inner contour matched to the outer contour of the tooth stump 1. The framework 3 in turn has an outer contour which the inner contour of the veneer must be defined to match.

FIG. 3 shows a first embodiment of a framework 3 on top of which is positioned a model 5 of a veneer. The model 5 is created on the basis of the three-dimensional geometric data for the framework 3 directly on the framework 3 itself or separately, and has an outer contour corresponding to the intended dental prosthesis.

FIG. 4 shows a second embodiment of a combination of framework 3 and model. The model consists of two model parts 5a, 5b, which are created separately from the framework 3 and mounted on the framework 3. In the context of the present invention, a separately created model is preferably mounted on a framework manually using an articulator, especially if the inner contour of the model does not correspond to the outer contour of the framework (see above).

FIG. 5 shows a third embodiment of a combination of framework 3 and model 5c. Model 5c corresponds to model 5 in FIG. 3, with a positive mould 7 of a casting channel being additionally added to model 5c. Model 5c is embedded in a fireproof embedding compound 9 along with the framework 3.

FIG. 6 shows a fourth embodiment of a combination of framework 3 and model 5d. As also shown in FIG. 5, model 5d is embedded in a fireproof embedding compound 9 along with the framework 3 and has a positive mould 7 for a casting channel. On the side facing away from the framework 3, model 5d has a closed outer surface (outer contour), whereas on the side facing the framework 3 and inside the positive mould 7 there are cavities 10. The inner contour of model 5d replicates the veneer to be produced (see FIGS. 8 and 9, reference 15). The closed outer surface of model 5d prevents the embedding compound 9 from penetrating into the space provided for the casting mould, whilst the cavities 10 serve to save on material and make it easier to remove the model material.

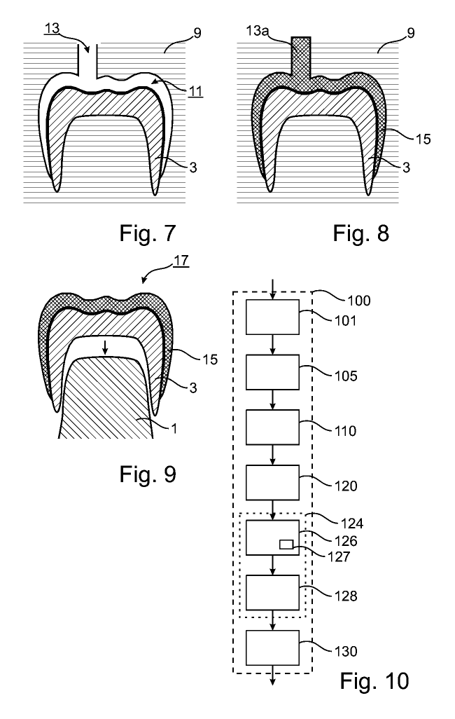

FIG. 7 shows the framework 3 embedded in an embedding compound 9 as shown in FIGS. 5 and 6, model 5c or 5d having been removed. In place of the model is a negative mould 11 of the veneer, which can be filled via a casting channel 13.

The view in FIG. 8 corresponds to the view in FIG. 7, with the negative mould 11 of the veneer filled with veneering material 15. The casting channel also contains veneering material 13a.

FIG. 9 shows the finished dental prosthesis 17 with the framework 3 and the veneer 15, which is fitted onto the tooth stump 1. The filled casting channel 13a was removed from the veneer 15 beforehand.

FIG. 10 shows a flow diagram illustrating a first embodiment of the method according to the invention for creating a dental prosthesis. In a first step 101 of the method 100 a framework is provided for the dental prosthesis to be created. The framework is then scanned (step 105), in other words three-dimensional geometric data for the framework is recorded. Alternatively, three-dimensional geometric data for the framework could also be provided along with the framework. The three-dimensional geometric data for the veneer is then defined on the basis of the now-known geometric data for the framework (step 110). This geometric data for the veneer is then used to create a model of the veneer (step 120), which in step 124 is used to make a negative mould of the veneer. Making the negative mould (step 124) involves encasing 126 the framework together with the model of the veneer in a moulding material and then removing 128 the model material. A channel is formed (step 127) during the encasing process 126 which serves to remove 128 the model material. The same channel is used to fill the negative mould with veneering material in step 130, thereby producing the dental prosthesis.

The negative mould is preferably filled by means of a hot pressing method (see FIG. 7, reference 11). The method of hot pressing a ceramic in a suitable mould is known per se to the person skilled in the art, so there is no need to describe this method in any more detail here. A method and an appropriate kiln for producing dental replacement parts by means of the hot pressing method is described for example in EP 0 231 773 A1. The use of this method to produce a solid ceramic dental structure with a zirconium oxide pin as the framework is proposed in DE 196 30 412 A1. A further development of the method from EP 0 231 773 A1 can be taken from DE 101 36 584 A1.

FIG. 11 shows a flow diagram illustrating a second embodiment of the method according to the invention for creating a dental prosthesis. In method 200 three-dimensional geometric data for the framework have already been defined. The three-dimensional geometric data for the veneer are defined (step 210) on the basis of the defined geometric data for the framework, with geometric data being output to a user and inputs received from this user (step 216) which are likewise used to define the geometric data for the veneer. In step 218 the framework is shaped independently of the definition of the three-dimensional geometric data for the veneer using the three-dimensional geometric data for the framework. The framework is shaped 218 by means of computer-aided manufacturing in an additive or subtractive manner. It can also be provided that between the processes of defining the veneer geometry 210 and shaping 218 the framework, data is exchanged which influences the other process. Shaping 218 can be performed before or after defining 210 the geometric data for the veneer or at the same time. As an alternative to the additive or subtractive shaping of the framework itself, the framework can also be produced by means of the lost wax method, with a model of the framework being produced by computer-aided means.

If the model of the veneer is to be created on the framework itself, shaping 218 of the framework is followed by creation 220 of a model of the veneer on the shaped framework using the defined geometric data for the veneer to be created. Alternatively, the model can also be created separately from the framework (step 220), wherein shaping 218 of the framework and creation 220 of the model of the veneer can take place at mutually independent times. On completion of the shaping 218 of the framework and creation 220 of the model the framework and model are assembled (step 222). It is also possible for part of the model to be created on the framework and part of it separately. The model can also be created by computer-aided means. The rapid prototyping method can advantageously be used here.

The basic methods of computer-aided manufacturing or creation, whether it be general additive or subtractive shaping such as milling or coating or a rapid prototyping method, can be regarded as being known, so no further explanation is needed here.

Following creation 220 or assembly 222, the combined framework and model is used to make a negative mould of the veneer (step 224). The model of the veneer and the framework are encased together in an embedding compound (step 226) and the material of the model is removed by thermal treatment (step 22830). The resulting mould is filled with a press ceramic to produce the veneered dental prosthesis (step 230).

FIG. 12 shows a third embodiment of the method according to the invention for creating a dental prosthesis. In a first step 302 of the method 300 the three-dimensional geometric data for a patient's teeth including a tooth stump is recorded. To this end a model of the teeth and the tooth stump is made by moulding and optically recorded. Alternatively, the data can be recorded by optical imaging (optical scanning) directly in the patient's mouth (or by X-ray imaging for example), by direct or indirect mechanical recording (mechanical scanning) or by other suitable means. Combinations of the various recording methods are likewise possible. The geometric data for the framework and the model of the veneer is then defined (steps 304 and 306). During the process of its definition 304 the geometric data for the framework is output to a user, who can influence the definition by means of corresponding inputs (step 308). In parallel to the definition 304 of the geometric data for the framework, the three-dimensional geometric data for the model is defined 306. This comprises definition 310 of the three-dimensional geometric data for the veneer to be produced, definition 312 of three-dimensional geometric data for cavities in the model (on the framework side) and definition 314 of three-dimensional geometric data for the casting channel system together with any channels for simplifying the subsequent removal of the model from the mould. The geometric data for the intended veneer, the cavities and the channel system is used to define the three-dimensional geometric data for the model. The defined geometric data is displayed individually and in combination to a user, who in turn can influence individual or all items of geometric data (step 316). In defining 306 the geometric data for the model, the previously recorded geometric data for the teeth and the tooth stump is taken into consideration. The geometric data for the framework and the geometric data for the model is likewise used in defining the other data.

Similarly to the embodiment of the method according to the invention described with reference to FIG. 11, the definition of the geometric data for the framework and the model of the veneer (steps 304, 306), which can alternatively be compiled in an individual combined definition process, is followed by production 318 of the framework and creation 320 of the model of the veneer. In principle, creation 320 of the model can take place on the framework or separately, at least for some parts. If parts of the model are created separately from the framework, the combination of the model and framework is completed in step 322.

In step 324 the framework is used together with the model to make a negative mould of the veneer. To this end the model is encased on the framework in a moulding material (step 326) and then removed (step 328). In step 330 the mould is filled with veneering material by known means.

Filling 330 the negative mould with veneering material creates the basic the dental prosthesis comprising the framework and veneer. Creation of the dental prosthesis is completed in step 332 by means of appropriate finishing work, in particular by removing the channel system.

FIG. 13 shows a first embodiment of the system according to the invention for creating a dental prosthesis. The system 40 for creating a dental prosthesis comprising a framework and a veneer comprises a definition means 42, a framework preparation means 44, a modelling means 46 and a filling means 48. The definition means serves to define three-dimensional geometric data for the veneer. In order to match the dental prosthesis to a specific set of teeth, the definition means 42, which is provided by a conventional computer with suitable software, receives three-dimensional geometric data for example for the set of teeth in question. On the basis of this tooth data the definition means 42 calculates the three-dimensional geometric data for the intended veneer. The definition means 42 also receives three-dimensional geometric data for the framework.

The geometric data for the framework is given to the framework preparation means 44, which is constituted by a conventional milling machine, for example, which is controlled and provided with data by the definition means 42. The framework preparation means 44 mills a framework with the defined geometric data from a ceramic block. Alternatively, a metal framework can be milled from a metal block.

The three-dimensional geometric data for the veneer defined by the definition means 42 is used to determine three-dimensional geometric data for a model of the veneer, which can also include the geometric data for an added casting channel, for example. This determination can be performed by the definition means 42 or by the modelling means 46. The modelling means 46, for example a conventional rapid prototyping device for stereolithography or 3D printing, uses the three-dimensional geometric data for the model of the veneer to create a model of the veneer, the inner contour of which for example differs from the outer contour of the framework.

The created model is mounted on the manufactured framework, preferably by hand using an articulator, especially if the inner contour differs from the outer contour of the framework. The framework and model are encased together by known means in an embedding compound, after which the material of the model is removed from the mould thus created to leave a negative mould of the veneer. Removal preferably takes place by burning or melting out the model material, which is preferably a wax or a plastic.

The negative mould is filled by the filling means 48, thus producing the dental prosthesis. The filling means is for example a hot pressing kiln described in EP 0 231 773 A1 or DE 101 36 584 A1.

FIG. 14 shows a second embodiment of the system according to the invention for creating a dental prosthesis. The system 50 for creating a dental prosthesis comprising a framework and a veneer is substantially more complex than that shown in FIG. 13 and includes a definition means 52, a framework preparation means 54, a modelling means 56, a mould making means 58, a filling means 60, a control unit 62, an output means 64, an input means 66 and a recording means 68. The continuous arrows linking the components in the diagram for FIG. 13 indicate a data flow, whilst the broken arrows indicate a movement of an object such as a framework, a model or the dental prosthesis. The system components per se are adequately known to the person skilled in the art, such that it is sufficient to state the functions of the components and to leave it to the person skilled in the art to determine appropriate structural features on the basis of his specialist knowledge. It should be noted that instead of or in addition to moving the prosthesis components, the system components can also be moved.

The control unit 62 controls and manages the processes and data in the system 50 centrally. Alternatively, it is possible for some or all of the functions of the control unit to be given to other components of the system 50, such that in some cases the control unit as an independent unit can be dispensed with. The control unit 62 can be provided for example by a conventional computer with appropriate software or by a microcontroller with hardware programming.

The definition means 52 serves to define three-dimensional geometric data and to this end receives inputs from the control unit 62. The extent of these inputs can range from simple basic or even standardised geometric data through to a complete set of three-dimensional geometric data for the (remaining) teeth into which the dental prosthesis is to be fitted, the tooth stump onto which the dental prosthesis is to be mounted, the framework and the dental prosthesis to be produced. The three-dimensional geometric data defined on this basis is sent from the definition means 52 to the control unit 62. The definition means 52 can also be integrated into the control unit 62 or can be a separate processor or computer.

The framework preparation means 54 like the definition means 52 is in contact with the control unit 62. The framework preparation means 54 comprises a provision unit 70 and a production unit 72. The provision unit 70 serves to provide a prefabricated framework for the dental prosthesis. The production unit 72 is intended for producing a framework, for which purpose three-dimensional geometric data can be defined by the control unit 62. The framework preparation means 54 is designed so as to forward the framework to the modelling means 56, the mould making means 58 and the recording means 68. For the production unit 72 in particular, a number of devices for computer-aided additive or subtractive fabrication are commercially available.

The modelling means 56 creates a model of the veneer on the basis of the three-dimensional geometric data for the veneer or the model, which is sent to it by the control unit 62. To enable the model optionally to be created directly on the framework, the modelling means 56 is designed so as to receive a framework from the framework preparation means 54. In addition, the modelling means 56 is designed so as to transfer the created model to the mould making means 58. Just as with the production unit 72 of the framework preparation means 54 in particular, a commercially available computer-aided manufacturing machine can be used as the modelling means 56.

The mould making means 58 receives the created model from the modelling means 56. If the model has not already been created on the framework, the mould making means 58 also receives the framework from the framework preparation means 54. The mould making means comprises an embedding unit 74 and a model removal unit 76. By means of the embedding unit 74 the model is embedded together with the framework in a moulding material. A simple embodiment of the embedding unit 74 consists of a container which is provided to hold the combination of framework and model and the moulding material and which fixes the moulding material until it solidifies around the combination. The model removal unit 76 serves to remove the model material from the mould created by the embedding process. An example of a model removal unit 76 is a kiln, which heats up the combination of framework and model in the moulding material in order to melt out, burn out or otherwise remove the model material. Another possibility consists of providing a solvent for removal, which dissolves the model material and is removed from the mould together with the model material. The negative mould of the veneer freed from the model material is transferred to the filling means 60. The mould making means 58 is controlled by the control unit 62.

The filling means 60 is provided for filling the negative mould of the veneer received from the mould making means 58, wherein the filling process creates the veneer on the framework, thereby producing the dental prosthesis. A large number of possible devices for filling the mould with ceramic material or plastic, for example, are available to the person skilled in the art, which can be used in a suitable manner as filling means 60. Examples of the hot pressing of ceramics are described in EP 0 231 773 A1, DE 196 30 412 A1 and DE 101 46 584 A1. The filling means 60 is also controlled and monitored by the control unit 62. The dental prosthesis is output from the filling means, with the option of also providing finishing steps in some circumstances.

The output means 64 is designed as a screen and serves to permit outputs to a user, in particular to enable the user to be aware of the three-dimensional geometric data used or determined in the system. The input means 66 serves to allow the user to make an input, the input being provided in particular for the purposes of manipulating or correcting the three-dimensional geometric data present in the system. The input means 66 comprises conventional input devices such as a keyboard, a mouse or a touch screen.

The recording means 68 is provided for recording three-dimensional geometric data, for example for a (remaining) set of teeth, a tooth stump or a framework. A number of different devices for recording three-dimensional geometric data are available to the person skilled in the art, the objects to be examined being in particular optically and/or mechanically scanned. In the broader sense methods such as X-ray tomography can also be regarded as being optical. The recorded data is sent to the control unit and used in the system.

The present invention provides in particular a method and a system for creating a dental prosthesis comprising a framework and a veneer, wherein three-dimensional geometric data corresponding to the existing teeth, which data can be used for example to create the metal or ceramic framework by means of computer-aided definition and manufacturing (CAD/CAM), is used for the definition of three-dimensional geometric data for the veneer, in particular for the computer-aided generation of geometric data. Using the defined three-dimensional geometric data, a model of the veneer is created which serves to create the dental prosthesis, by means of the lost wax method in particular.

A dental technician records by computer-aided means the geometric data for a master model on which he intends to undertake a dental restoration, for example a three-unit bridge in the anterior region. The data processed in the computer is used to produce the framework, for example by milling a densely sintered zirconium oxide block as a ceramic blank. The geometric data for the framework created in this way, in particular for its outer contour, is processed by the computer together with three-dimensional geometric data likewise recorded for the opposite set of teeth and used to define three-dimensional geometric data for a model of the veneer. Such a model, which may also be a multi-piece model, can be produced in plastic by stereolithography, for example. After mounting the model or model pieces on the ceramic framework, the whole unit is embedded in an embedding compound. When the embedding compound has hardened, the plastic is burnt out of the mould by heat treatment, in which process the model burns without residue. The remaining cavity can be filled with a veneering ceramic, by hot pressing for example, which together with the framework forms the dental prosthesis.

1. A method for creating a dental prosthesis comprising a framework and a veneer, such as, a crown, a bridge, an inlay or an onlay, the method comprising:
defining three-dimensional geometric data for the veneer;
providing the framework;
creating a model of the veneer on the basis of the three-dimensional geometric data for the veneer;
making a negative mould of the veneer by encasing the model between the frameworks and a moulding material and then removing the model; and
filling the negative mould with veneering material to produce the veneered dental prosthesis.

2. A method according to claim 1, further comprising, shaping the framework by means of computer-aided manufacturing.

3. A method according to claim 1, wherein the framework is shaped on the basis of predefined three-dimensional geometric data.

4. A method according to claim 1, wherein the framework comprises at least one of a metal, a metal alloy and a ceramic material.

5. A method according to claim 1, wherein the three-dimensional geometric data for the veneer is defined using three dimensional geometric data for the framework and a set of teeth.

6. A method according to claim 1, wherein the defining comprises recording three-dimensional geometric data for the framework, and one of a set of teeth and a tooth stump.

7. A method according to claim 1, wherein the creatin of the model of the veneer is performed by a rapid prototyping method.

8. A method according to claim 1, wherein the model of the veneer further comprises a positive mould for at least one channel thereby simplifying filling of the negative mould and/or removal of the model.

9. A method according to claim 1, wherein the created model of the veneer has a closed outer surface and has cavities on the side facing the framework.

10. A method according to claim 1, wherein removal of the model of the veneer comprises burning out the model of the veneer, the moulding material being a fireproof material.

11. A method according to claim 10, wherein the model of the veneer is created from one of a wax and a plastic.

12. A method according to claim 1, wherein the negative mould is filled with a veneering ceramic material by means of a hot pressing method.

13. A method according to claim 1, wherein a colour gradation is established in the veneer when the negative mould is filled by press-moulding a blank with a colour gradation.

14. A method according to claim 1, wherein the method includes creating and using a multi-piece model so as to create a multi-piece dental prosthesis.

15. A method for creating a dental prosthesis comprising a framework and a veneer, such as, a crown, a bridge, an inlay or an onlay, comprising:
shaping the framework by means of computer-aided manufacturing using predefined three-dimensional geometric data for the framework,
defining three-dimensional geometric data for the veneer using the three-dimensional geometric data for the framework using at least one of user inputs and predefined three-dimensional geometric data for a set of teeth into which the dental prosthesis is to be fitted;
creating by using a computer-aided device a model of the veneer on the basis of the three-dimensional geometric data for the veneer
making a negative mould of the veneer by encasing the model between the framework and a moulding material and then removing the model; and
filling the negative mould with a press ceramic to produce the veneered dental prosthesis.

16. A system for creating a dental prosthesis the prosthesis comprising a framework and a veneer, such as a crown, a bridge, an inlay or an onlay, the system comprising:
a definition means for defining three-dimensional geometric data for the veneer,
a framework preparation means for producing the framework,
a modelling means for creating a model of the veneer on the basis of the three-dimensional geometric data for the veneer, and
a filling means for filling a negative mould, made by encasing the model between the framework and a moulding material and then removing the model, with veneering material to produce the veneered dental prosthesis.

17. A computer program product for use on a computer system for causing the creation of a dental prosthesis the prosthesis-comprising a framework and a veneer according to, the computer program product comprising a computer-usable medium having computer readable program code thereon, the computer readable program code comprising at least one of:
(a) program code for defining-three-dimensional geometric data for the veneer;
(b) program code for producing the framework; and
(c) program code for creating a model of the veneer on the basis of the three-dimensional geometric data for the veneer.

18. A method according to claim 1, wherein the providing the framework further comprises producing the framework.

19. A method according to claim 1, wherein the three-dimensional geometric data is selected from data for the veneer on the framework and data for the veneer separate from the framework.

20. A method according to claim 2, wherein the shaping includes one of additive and subtractive shaping.

21. A method according to claim 2, wherein the computer-aided manufacturing comprises rapid prototyping.

22. A method according to claim 5, wherein the three-dimensional geometric data is defined using user inputs.

23. A method according to claim 7, wherein the rapid prototyping method comprises one of milling, 3D printing, and stereolithography.

24. A method according to claim 8, wherein the channel is a casting channel.

25. A method according to claim 10, wherein the fireproof material is an embedding compound.

26. A method-according to claim 1, wherein removal of the model of the veneer comprises melting out the model of the veneer, the moulding material being a fireproof material.

27. A method according to claim 11, wherein the model of the veneer can be removed without residue by one of burning and melting.

28. A method according to claim 15, wherein the shaping comprises one of additive and subtractive shaping.

29. A method according to claim 15, wherein the three-dimensional geometric data is selected from data for the veneer on the framework and data for the veneer separate from the framework.

30. A method according to claim 15, wherein the removing includes one of melting out or burning out the model.

31. A system according to claim 16, wherein the three-dimensional geometric data is selected from data for the veneer on the framework and data for the veneer separate from the framework.
